(19) United States
(12) Patent Application Publication
(10) Pub. No.: US 2009/0228261 A1
(43) Pub. Date: Sep. 10, 2009

(54) METHOD FOR CHARACTERIZING A SOFTWARE APPLICATION

(75) Inventors: Sunita Chulani, San Jose, CA (US); Avik Sinha, New Rochelle, NY (US); Clay Williams, New York, NY (US)

Correspondence Address: RYAN, MASON & LEWIS, LLP, 1300 POST ROAD, SUITE 205, FAIRFIELD, CT, 06824, US

(73) Assignee: International Business Machines Corporation, Armonk, NY (US)

(21) Appl. No.: 12/043,175

(22) Filed: Mar. 6, 2008

(51) Int. Cl. G06F 9/455

(52) U.S. Cl. 703/22

(57) ABSTRACT

Techniques are provided for calculating effort of a software application. The techniques include obtaining a detailed use case model (DUCM) of the software application, computing a multi-dimensional metrics vector (MMV) based on the DUCM, using a size model for the MMV to estimate a size of the software application, and inputting the MMV and the size into an effort model, wherein the effort model is used to calculate the effort required to build the software application. Techniques are also provided for representing a DUCM of a software application.

### FIELD OF THE INVENTION

The present invention generally relates to information technology, and, more particularly, to software analysis.

### BACKGROUND OF THE INVENTION

In order to plan the development of a software application, practitioners have to estimate the amount of time, the number or personnel required, and the amount of other resources required. Existing approaches for estimating or calculating effort for a software project use parametric models pre-populated by past project data. Most parametric models require a metric reflecting the size of the software under development.

An existing approach for estimating the size of a software application includes measuring the application in terms of number of lines in a source code (SLOC). SLOC can be used, for example, for estimating, by way of analogy, projects with similar functionality and programming languages, as well as for post-partum analysis. However, the effectiveness of SLOC as a sizing measure for prediction models is lessened by the fact that the measure is available only very late in the software life cycle. Also, with the advent of software development paradigms that frequently re-use existing code and automatically generate source code, an approach using this kind of a measure requires substantial adjustment.

Other existing approaches for measuring software size include taking action when architectural and/or design decisions have been made. These metrics, however, are very difficult to measure, especially, for example, function points which require function point trained experts.

Changes in software development techniques have led to a need for a new sizing approach that aligns with existing approaches, tools and practices and can be used early in the life cycle.

Furthermore, a functional description of a software application is frequently captured using use cases that describe actor-system interaction descriptions.

### SUMMARY OF THE INVENTION

Principles of the present invention provide techniques for characterizing a software application. An exemplary method (which can be computer-implemented) for calculating effort of a software application, according to one aspect of the invention, can include steps of obtaining a detailed use case model (DUCM) of the software application, computing a multi-dimensional metrics vector (MMV) based on the DUCM, using a size model for the MMV to estimate a size of the software application, and inputting the MMV and the size into an effort model, wherein the effort model is used to calculate the effort required to build the software application.

In an embodiment of the invention, an exemplary method for representing a detailed use case model (DUCM) of a software application can include obtaining a context model, wherein the context model describes one or more classes and one or more properties defining a domain of the software application, obtaining a behavior model, wherein the behavior model comprises one or more actors and a set of one or more use cases that the one or more actors can perform, and using the context model and the behavior model to represent a DUCM of the software application.

At least one embodiment of the invention can be implemented in the form of a computer product including a computer usable medium with computer usable program code for performing the method steps indicated. Furthermore, at least one embodiment of the invention can be implemented in the form of an apparatus including a memory and at least one processor that is coupled to the memory and operative to perform exemplary method steps.

These and other objects, features and advantages of the present invention will become apparent from the following detailed description of illustrative embodiments thereof, which is to be read in connection with the accompanying drawings.

### BRIEF DESCRIPTION OF DRAWINGS

FIG. 1 is a diagram illustrating a data model of a DUCM, according to one aspect of the invention;

FIG. 2 is a diagram illustrating a use case behavioral model of a DUCM, according to one aspect of the invention;

FIG. 3 is a diagram illustrating a description of a use case of DUCM example, according to one aspect of the invention;

FIG. 4 is a system diagram of an exemplary computer system on which at least one embodiment of the present invention can be implemented;

FIG. 5 is a flow diagram illustrating an exemplary method for calculating effort of a software application, according to another aspect of the invention; and

FIG. 6 is a flow diagram illustrating an exemplary method for representing a detailed use case model (DUCM) of a software application, according to another aspect of the invention.

### DETAILED DESCRIPTION OF PREFERRED EMBODIMENTS

Principles of the present invention include techniques for characterizing a software application on the basis of its detailed use case model. The level of detail of use case models varies across software projects, making their use in automated software engineering difficult. However, one or more embodiments of the invention define a canonical representation of use case models and refer to it as the detailed use case model (DUCM). Such a form will lead to machine-processable use cases and use of such artifacts for software engineering activities such as, for example, estimation and test case generation.

Principles of the present invention include estimating the effort for a software application using use cases that align with existing approaches, tools and practices, and can be used early in the software life cycle.

One or more embodiments of the invention include computing a multi-dimensional metrics vector (MMV) and estimating the size of a software project based on a detailed use case model (DUCM). A DUCM includes a set of use cases and data model to define concepts described in use cases. The use cases in a use DUCM describe scenarios of execution of a software application by a particular actor, for example, a chain of actor-system interactions in the form of an actor providing input to the system, a system providing output to the actor and/or a system updating state of the system.

Also, one or more embodiments of the present invention include computing a MMV of a system by using the information available in such actor-system interaction descriptions. Once a use case model of the software application is available, size and MMV computations can be automatically produced. The size and MMV computations can be used as inputs to a parametric model used for effort estimation. Consequently, an effort estimate of an application can be derived for developing the software application.

DUCMs can be used, for example, for describing functional requirements of a system. The information is available at a very early phase of the software development lifecycle, before the architectural and design decisions are made. As a result, DUCM based estimation can be used to plan projects at the very beginning of software life cycles.

DUCMs are also easy to capture and maintain. Therefore, if in any development cycle, DUCMs are not available, they can be produced easily for planning purposes, as described herein. The overhead involved is much less than performing measurements on the basis of, for example, function points or object points.

Also, in one or more embodiments of the present invention, the computation of MMV is automated and can be implemented as a tool. Therefore, the computations can be fast and repeatable.

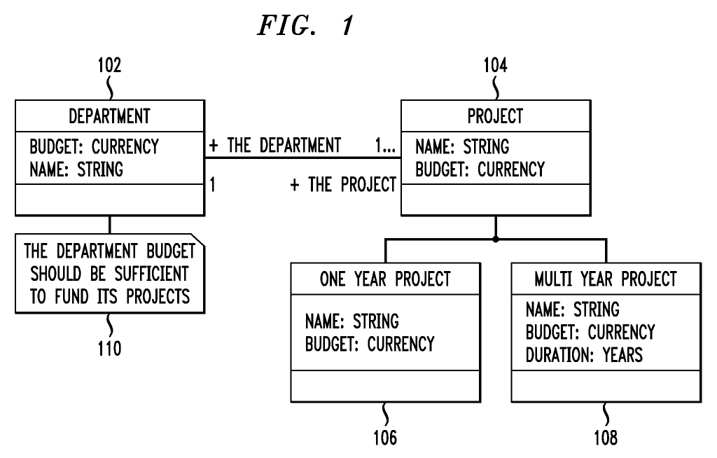

FIG. 1 is a diagram illustrating a data model of a DUCM, according to one aspect of the invention. A data model is analogous to a UML class diagram. For example, a simple system of department and projects can have a data model as depicted in FIG. 1.

The data model presented in FIG. 1 has classes department 102, project 104, one year project 106 and multi year project 108. All the classes have a set of properties. The relationship between department 102 and project 104 can be defined as one to many, as specified by multiplicities. One instance of a department can be associated with zero or more instances of projects, and each instance of a project is preferably associated with at most one instance of a department. The classes one year project 106 and multi year project 108 are derived from the base class project 104.

A data model can also have constraints defined on its classes and attributes. These constraints form the system invariants and can be used to define any enterprise rules that an application needs to satisfy. For example, in FIG. 1, an enterprise rule 110 is described as “The department budget should be sufficient to fund its projects.”

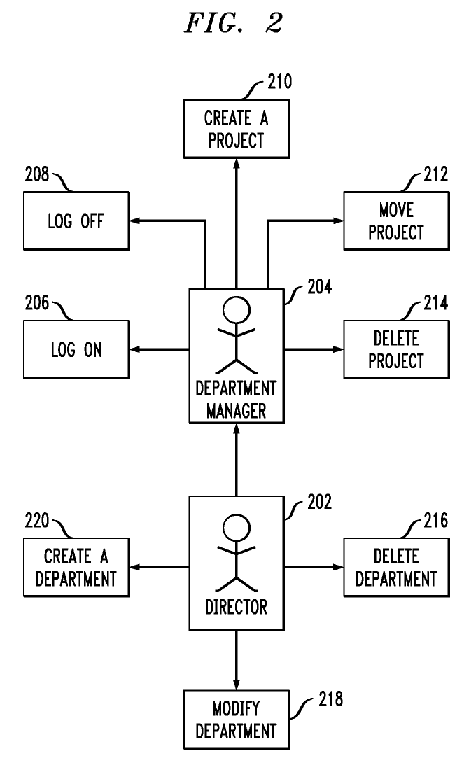

FIG. 2 is a diagram illustrating a use case behavioral model of a DUCM, according to one aspect of the invention. A behavioral model includes actors and a set of use cases that each actor can perform. For example, a use case model can describe actions in a system as shown in FIG. 2.

The actors in FIG. 2 are the department manager 204 and the director 202. The department manger 204 can perform functionalities such as, for example, log on 206, log off 208, create a project 210, move a project 212 and delete project 214. The director 202 is a specialized case of an actor and has an extra set of functionalities that it can perform which include, for example, create a department 220, modify a department 218 and delete a department 216.

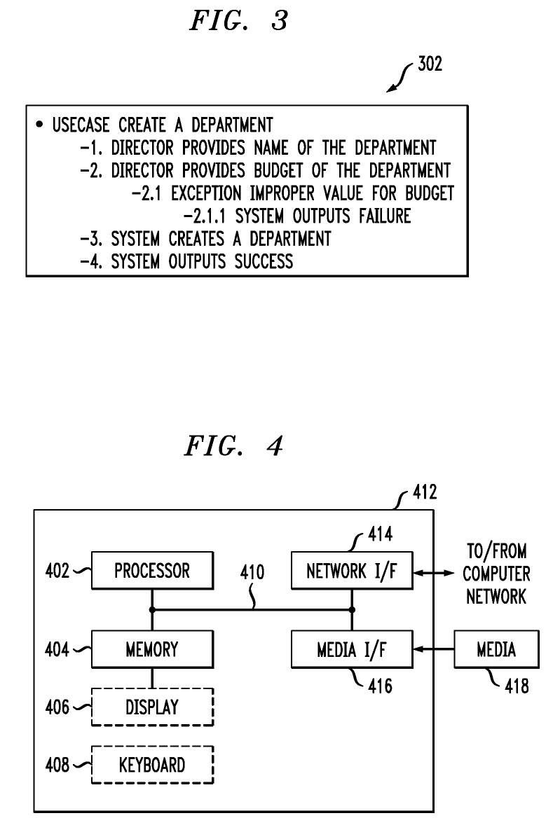

FIG. 3 is a diagram illustrating a description of a use case of DUCM example 302, according to one aspect of the invention. Each of the use cases in a DUCM can have a set of specifications describing the actions that the user may perform within the use case. For example, for “create a department,” the actor “director” can specify actions, as depicted in FIG. 3.

The use case in FIG. 3 includes two input actions including the director providing the name and budget of the department. The use case can have computation statements such as, for example, “system creates a department.” A computation statement can alter the state of the system. Use cases can also have output statements that define the use case's observable outputs. For example, one can define an exception to an action in a use case. Such exceptions are meant to define the behavior of the system in the event that the action fails. For example, in FIG. 3 there is an exception for the input event “director provides budget of the department” defining the behavior if the event value provided for the budget is improper.

Principles of the present invention include providing a standard form for capturing a use case model. In one or more embodiments of the present invention, part of the MMV of an application is computed automatically from a data model using at least one of the following indicators:
Number of classes: Total number of classes that define the domain of the application. As seen in FIG. 1, for example, it is four (Department 102, Project 104, One year Project 106 and Multi Year Project 108).
Number of root classes (Total number of base classes): This count excludes the inherited and/or specialized classes. In FIG. 1, for example, it is two, since only Department 102 and Project 104 are the root classes.
Number of global objects: A global object is defined by an instance of a class that affects the state of the system but is not created as part of any use case, and can be accessed from any of the use cases. For example, a system can be represented as a global object.
Number of enterprise rules: Enterprise rules are the rules of the enterprise defined using the classes and properties of a system. In FIG. 1, for example, we have only one enterprise rule 110 saying “The department budget should be sufficient to fund its projects.”
Number of inheritance trees: This is the count of the number of inheritance hierarchy trees used in defining a system. In FIG. 1, for example, this is one because we just have the inheritance tree for projects.
Depth of inheritance for classes: This is the average depth of inheritance for all of the classes. Depth of inheritance is defined as the depth in the inheritance hierarchy. In FIG. 1, for example, for the four classes we have the following values for the depth of inheritances. Department-1, Project-1, One year Project-2 and Multi Year Project-2. This means that the average depth of inheritance=(1+1+2+2)/4=1.5.
Number of children of classes: This is the number of immediate successors of a class in the hierarchy. For example, for the project class 104 it is two.
Cross cutting concerns in the classes: This is the count of enterprise rules defined over different properties of different classes. In FIG. 1, the count is one because the enterprise rule concerns both the classes department 102 and project 104.

In one or more embodiments of the present invention, part of the MMV of an application is measured automatically from a behavioral model using at least one of the following indicators:
Number of use cases: The number of use cases is the count of use cases in the model. In FIG. 2, for example, it is eight.
Net number of statements in a use case description: For the create a department use case 220 in FIG. 2, for example, it is four.
Average fan in (number of use cases that include this use case): Sometimes a use case may include other use cases. This implies that the parent use case will perform all the actions of the included use case along with its original action(s). For example, if there is a use case named “Create Department with Project” which forms a new department with a new project, it might include the use cases “Create a department” and “Create a project.” Consequently, the use cases “Create a department” and “Create a project” will have a fan in of one.
Fan out (number of included use cases) plus extension points: An extension point provides a mechanism to conditionally extend the actions of a use case. The condition is specified in the extending use case in terms of its parameters. For example, there might be an extension point for “Create Department with Project” that allows the addition of a specified number of projects in the department. In such a scenario, the fan out for the use case will be calculated as one (for the extension point) plus two (for the inclusions as described in the fan in measure) for a total of three.
Number of alternate flows (exceptions plus extension points plus conditional flows): Use cases can have multiple flows defined by exceptions, extensions and conditional statements. A count of such flows can be made. For example, for “create project” use case, as described in the example above, there is one alternate flow.
Number of input parameters (could correlate to input events): The input events can provide a count on the number of input parameters. For example, the number of input parameters in the use case create a project 210 equals two (that is, name, and budget of the department).
Number of output parameters (could correlate to output events): The output events can provide a count on the number of output parameters. For example, the number of output parameters in the use case create a project 210 equals two (that is, failure, and success of budget definition process).
Number of actors (The total number of actors in a use case): In FIG. 2, for example, there are two actors (that is, Director 202, and Department Manager 204).
Number of results: Each flow in a use case defines a result. The number of results is computed by computing the net number of flows in the use case. In the “Create project” use case, there are two results, one corresponding to the main flow and the other corresponding to the alternate flow.
Number of update statements: This is the count of the number of statements in a use case that result in state updates. Thus, it is the count of statements that are computations involving the creation and updating of objects. For example, in the create a department use case 220, we have one update statement regarding creation of a department object (that is, statement #3 in FIG. 3).
Number of predicates: The number of predicates is the number of conditional flows in a given use case. The examples described above have no such flows, but a conditional flow can be effected by use cases with “if <condition> then <action> else <action>” constructs. For example, in FIG. 2, create a department 220, one could have specified an alternate action instead of throwing an exception for improper budget condition.
Complexity of logical expressions: A logical expression in a predicate and/or guard of exception can vary in complexity. The complexity can be measured by the number of free variables (that is, the number of variables that are independent and affect the truth value of any condition), the number of relational operators (operators such as, for example, <, >, ==, ≦, and ≧) and the number of logical operators (for example, AND, OR, and NOT). For example, in the guard condition of improper budget, which can be expressed as budget <0, there is one free variable (budget) and one relational operator (<).
Number of user and/or system driven updates: Some of the updates are system-driven while others are driven by the actors. For example, an action may be stated as “System determines . . . ” or as “The Director creates . . . ” While the former is a system-driven update, the latter is a user driven update. The number of user-driven updates and system driven updates can be easily differentiated. A ratio between such updates may indicate a level of automation that is desired of the system.

In one or more embodiments of the present invention, part of the MMV is measured automatically from various structures (for example, a cell graph, a data flow diagram and/or a control flow diagram) derived from a DUCM using at least one of the following indicators:
Cyclomatic complexity: Cyclomatic complexity is a measure of complexity based on the control flow graphs. It indicates the number of faces in a control flow. The cyclomatic complexity of an application can be computed, for example, from a use case flow graph. A use case flow graph sequences use cases for a given scenario for a specific actor. For example, if we have ‘N’ use cases in a use case flow graph, and ‘p’ of which are connected through ‘E’ number of edges, then the cyclomatic complexity (CC) equals E−N+p.
Dataflow complexity: Dataflow complexity indicates the complexity of the data exchange between use cases. This can be determined automatically from use case flow graphs by the average dependency between use cases. A dependency can be determined by studying the number of “monitored variables” and “controlled variables” in a use case. A “monitored variable” is a variable whose value determines the behavior of the use case, and a “controlled variable” is a variable that is determined through the actions in a use case.
Response for a class: This is the number of methods that can be executed in response to a message received by an object of that class. Such a number can be estimated, for example, from the use case flow graphs. The response for a class can be derived by identifying the object lifecycles and object interactions.

The size of an application is calculated by using a parametric model that is developed based on the past data. The development of the parametric model may, for example, include the following steps. The complexity of use cases is determined based on the MMV of a DUCM. Complexity may be indicated by a single use case complexity measure or by a function of multiple use case complexity indicators. The size of the application can be expressed (that is, calculated) as a function of one or more weighted complexities of the use cases. The function may account for other factors such as, for example, the number of actors, the number of use cases in an application model, etc.

In creating a size metric, use case measurements and actual size measurements of the application are collected as data that will be used to calibrate the estimation model. Through calibration, the weights of the use case complexities will be finalized. The size metric will be correlated with other size metrics such as, for example, source lines of code, function points, etc. This correlation will ensure that the developed size metric yields size measurements that are usable by other measurement models. The sizing model may also be further refined in order to account for any anomalies.

An effort calculation can be derived based on another parametric model. The development of this parametric model may, for example, include the following steps. The system is measured in terms of, for example, personnel characteristics, team distribution, amount of reuse, etc. These metrics are used to characterize the type of system whose effort is being predicted.

The effort for development is determined as a function of the size and system and/or application metrics. In order to calibrate the effort model, effort and other metrics data is collected. The calibration will help determine the weights and powers for system indicators in the effort model.

The sizing model is correlated with the effort model to develop a use case effort estimation model. The effort model may, for example, be further refined in order to account for any anomalies.

One or more embodiments of the present invention include deriving a DUCM of a software application by defining a model of the application domain and describing the application behavior using use cases. Defining a model of the application domain can include defining prominent domain types using, for example, UML class diagrams and/or ontologies. Defining a model of the application domain may also include defining enterprise rules for the domain of the application, defining object keys in UML classes and defining a multiplicity of object valued attributes.

Modeling an application may also include defining use case behavior in terms of input, output, pre-condition and effect, as well as defining the types of variables in input, output, pre-condition and effect in terms of domain model classes and primitive types. Also, use case pre-conditions may be defined via predicates defined on objects of type specified by the model of the application domain.

Additionally, parameters of the use case may be defined, wherein parameters are identified for input actions and output actions. Further use case effects may be specified, including use case effects in the form of creation of objects, updating attributes of created objects, adding links between created objects, deleting created objects and deleting the links created between existing objects.

A variety of techniques, utilizing dedicated hardware, general purpose processors, software, or a combination of the foregoing may be employed to implement the present invention. At least one embodiment of the invention can be implemented in the form of a computer product including a computer usable medium with computer usable program code for performing the method steps indicated. Furthermore, at least one embodiment of the invention can be implemented in the form of an apparatus including a memory and at least one processor that is coupled to the memory and operative to perform exemplary method steps.

At present, it is believed that the preferred implementation will make substantial use of software running on a general-purpose computer or workstation. With reference to FIG. 4, such an implementation might employ, for example, a processor 402, a memory 404, and an input and/or output interface formed, for example, by a display 406 and a keyboard 408. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input and/or output interface” as used herein, is intended to include, for example, one or more mechanisms for inputting data to the processing unit (for example, mouse), and one or more mechanisms for providing results associated with the processing unit (for example, printer). The processor 402, memory 404, and input and/or output interface such as display 406 and keyboard 408 can be interconnected, for example, via bus 410 as part of a data processing unit 412. Suitable interconnections, for example via bus 410, can also be provided to a network interface 414, such as a network card, which can be provided to interface with a computer network, and to a media interface 416, such as a diskette or CD-ROM drive, which can be provided to interface with media 418.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and executed by a CPU. Such software could include, but is not limited to, firmware, resident software, microcode, and the like.

Furthermore, the invention can take the form of a computer program product accessible from a computer-usable or computer-readable medium (for example, media 418) providing program code for use by or in connection with a computer or any instruction execution system. For the purposes of this description, a computer usable or computer readable medium can be any apparatus for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory (for example, memory 404), magnetic tape, a removable computer diskette (for example, media 418), a random access memory (RAM), a read-only memory (ROM), a rigid magnetic disk and an optical disk. Current examples of optical disks include compact disk-read only memory (CD-ROM), compact disk-read and/or write (CD-R/W) and DVD.

A data processing system suitable for storing and/or executing program code will include at least one processor 402 coupled directly or indirectly to memory elements 404 through a system bus 410. The memory elements can include local memory employed during actual execution of the program code, bulk storage, and cache memories which provide temporary storage of at least some program code in order to reduce the number of times code must be retrieved from bulk storage during execution.

Input and/or output or I/O devices (including but not limited to keyboards 408, displays 406, pointing devices, and the like) can be coupled to the system either directly (such as via bus 410) or through intervening I/O controllers (omitted for clarity).

Network adapters such as network interface 414 may also be coupled to the system to enable the data processing system to become coupled to other data processing systems or remote printers or storage devices through intervening private or public networks. Modems, cable modem and Ethernet cards are just a few of the currently available types of network adapters.

In any case, it should be understood that the components illustrated herein may be implemented in various forms of hardware, software, or combinations thereof, for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

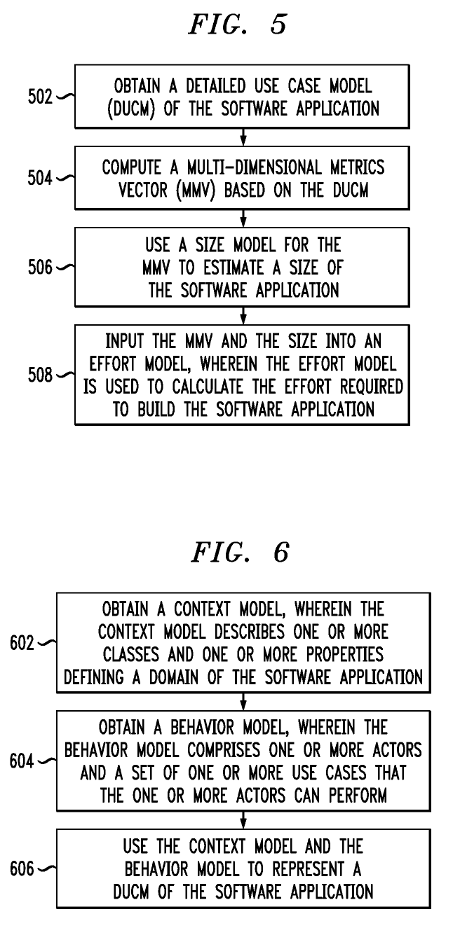

FIG. 5 is a flow diagram illustrating an exemplary method for calculating effort of a software application, according to another aspect of the invention. Step 502 includes obtaining a detailed use case model (DUCM) of the software application. A DUCM can include, for example, a behavioral model, wherein the behavioral model includes a set of use cases and use case descriptions, and a data model, wherein the data model models concepts used in the case descriptions. A use case description can include, for example, input interactions between an actor and a system, output interactions between an actor and a system, and updates in system state. Also, a use case description can be, for example, in natural language. Further, obtaining a DUCM of the software application can include translating a natural language description into a formal description.

Step 504 includes computing a multi-dimensional metrics vector (MMV) based on the DUCM. Computing a MMV can include measuring complexity of the software application from structures derived from a use case estimation model using indicators such as, for example, cyclomatic complexity, dataflow complexity and response for a class. Complexity of a software application is an objective measure of the software application that indicates the difficulty of producing the software application. The one or more indicators can also be, for example, derived on the basis of a use case model. A use case is a way of modeling a software application.

Step 506 includes using a size model for the MMV to estimate a size of the software application. Development of a size model can include, for example, determining complexity of use cases based on the MMV of the DUCM, wherein complexity is indicated by a single use case complexity measure and/o a function of multiple use case complexity indicators. Also, development of a size model can include expressing the size of a software application as a function of weighted complexities of the use cases, as well as collecting use case measurements and size measurements of the software application to create a size metric, wherein the use case measurements and size measurements are used to calibrate an estimation model. Further, the size model can be correlated with other size metrics, analogous source lines of code, and/or function points.

A use case model is a description of the software application in terms of actor-system interaction. Based on this, the complexity indicators can be calculated. As described above, the effort of producing the software application can be computed by using these complexity indicators as well as the size information. A formula can be produced in which one can estimate effort directly from use cases. Such a formula is identified as a use case effort estimation model.

Step 508 includes inputting the MMV and the size into an effort model, wherein the effort model is used to calculate the effort required to build the software application. Development of an effort model can include, for example, measuring the software application in terms of personnel characteristics, team distribution and/or amount of reuse to create application metrics. Inputting the complexity and size into an effort model can also include developing the effort model as a function of the size model and application metrics, and calibrating the effort model by collecting effort and/or other metrics data. Additionally, the techniques described herein may also include correlating a size model with the effort model to develop a use case effort estimation model.

FIG. 6 is a flow diagram illustrating an exemplary method for representing a detailed use case model (DUCM) of a software application, according to another aspect of the invention. Step 602 includes obtaining a context model, wherein the context model describes one or more classes and one or more properties defining a domain of the software application. The context model can include one or more constraints defined on its one or more classes and one or more attributes, wherein the one or more constraints form one or more system invariants used to define an enterprise rule.

Step 604 includes obtaining a behavior model, wherein the behavior model comprises one or more actors and a set of one or more use cases that the one or more actors can perform. Each use case can be, for example, a sequence of one or more statements defining an actor-system interaction. Also, each use case can have a set of one or more specifications describing one or more actions that the actor may perform within the use case. Additionally, each use case can have one or more output statements that define one or more observable outputs of the use case.

Step 606 includes using the context model and the behavior model to represent a DUCM of the software application. This step can be performed, for example, manually by the user modeling the use cases. The user, as illustrated above in FIG. 3, can describe, in a stepwise fashion, the details of a use case. For example, “create department” is a use case in the behavioral model, and “department” and “project” are classes in the context model. A functional description is created, for example, by detailing the steps of “creating a department” in terms of operations on “departments” and “projects” in stepwise fashion.

At least one embodiment of the invention may provide one or more beneficial effects, such as, for example, the ability to be effectively used early in the software life cycle.

It should be noted that the invention is not limited to the precise exemplary embodiments detailed above, and that various other changes and modifications may be made by one skilled in the art. For example, the description of a use case model does not preclude the use of use case models that may differ in form but may carry the same information. Existing use case models, for example, can be transformed to the one required as long as the necessary information is present.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for calculating effort of a software application, comprising the steps of:
obtaining a detailed use case model (DUCM) of the software application;
computing a multi-dimensional metrics vector (MMV) based on the DUCM;
using a size model for the MMV to estimate a size of the software application; and
inputting the MMV and the size into an effort model, wherein the effort model is used to calculate the effort required to build the software application.

2. The method of claim 1, wherein the DUCM comprises:
a behavioral model, wherein the behavioral model comprises a set of use cases and one or more use case descriptions; and
a data model, wherein the data model models one or more concepts used in the one or more use case descriptions.

3. The method of claim 2, wherein each use case description comprises:
one or more input interactions between an actor and a system;
one or more output interactions between an actor and a system; and
one or more updates in system state.

4. The method of claim 2, wherein each use case description is in natural language.

5. The method of claim 2, wherein the data model comprises one or more indicators, wherein the one or more indicators comprise at least one of number of classes, number of root classes, number of global objects, number of enterprise rules, number of inheritance trees, depth of inheritance for classes, number of children of classes and cross cutting concerns in the classes.

6. The method of claim 2, wherein the behavioral model comprises one or more indicators, wherein the one or more indicators comprise at least one of number of use cases, net number of statements in a use case description, average number of use cases that include a use case, number of included use cases, number of alternate flows, number of input parameters, number of output parameters, number of actors, number of results, number of update statements, number of predicates, complexity of logical expressions and number of user and system driven updates.

7. The method of claim 1, wherein obtaining a DUCM of the software application comprises translating a natural language description into a formal description.

8. The method of claim 1, wherein the step of computing a multi-dimensional metrics vector (MMV) based on the DUCM comprises measuring complexity of the software application from one or more structures derived from a use case estimation model using one or more indicators, the one or more indicators in turn comprising at least one of cyclomatic complexity, dataflow complexity and response for a class.

9. The method of claim 8, wherein the one or more structures comprise at least one of a cell graph, a data flow diagram and a control flow diagram.

10. The method of claim 1, wherein in the step of using a size model for the MMV to estimate a size of the software application, development of the size model comprises the following steps:
determining complexity of one or more use cases based on the MMV of the DUCM, wherein complexity is indicated by at least one of a single use case complexity measure and a function of multiple use case complexity indicators;
expressing the size of the software application as a function of one or more weighted complexities of the one or more use cases;
collecting one or more use case measurements and one or more size measurements of the software application to create a size metric, wherein the one or more use case measurements and one or more size measurements are used to calibrate an estimation model; and
correlating the size model with at least one of:
one or more other size metrics,
one or more analogous source lines of code, and
one or more function points.

11. The method of claim 1, wherein the step of inputting the MMV and the size into an effort model, development of the effort model comprises the following steps:
measuring the software application in terms of at least one of one or more personnel characteristics, team distribution and amount of reuse to create one or more application metrics;
developing the effort model as a function of the size model and one or more application metrics; and
calibrating the effort model by collecting at least one of effort and one or more other metrics data.

12. The method of claim 11, further comprising the additional step of:
correlating a size model with the effort model to develop a use case effort estimation model.

13. A method for representing a detailed use case model (DUCM) of a software application, comprising the steps of:
obtaining a context model, wherein the context model describes one or more classes and one or more properties defining a domain of the software application;
obtaining a behavior model, wherein the behavior model comprises one or more actors and a set of one or more use cases that the one or more actors can perform; and
using the context model and the behavior model to represent a DUCM of the software application.

14. The method of claim 13, wherein the context model comprises one or more constraints defined on its one or more classes and one or more attributes, wherein the one or more constraints form one or more system invariants used to define an enterprise rule.

15. A computer program product comprising a computer useable medium having computer useable program code for calculating effort of a software application, said computer program product including:
computer useable program code for obtaining a detailed use case model (DUCM) of the software application;
computer useable program code for computing a multi-dimensional metrics vector (MMV) based on the DUCM;
computer useable program code for using a size model for the MMV to estimate a size of the software application; and
computer useable program code for inputting the MMV and the size into an effort model, wherein the effort model is used to calculate the effort required to build the software application.

16. The computer program product of claim 15, wherein the DUCM comprises:
a behavioral model, wherein the behavioral model comprises a set of use cases and one or more use case descriptions; and
a data model, wherein the data model models one or more concepts used in the one or more use case descriptions.

17. The computer program product of claim 16, wherein each use case description comprises:
one or more input interactions between an actor and a system;
one or more output interactions between an actor and a system; and
one or more updates in system state.

18. The computer program product of claim 15, wherein in the computer useable program code for using a size model for the MMV to estimate a size of the software application, development of the size model comprises:
computer useable program code for determining complexity of one or more use cases based on the MMV of the DUCM, wherein complexity is indicated by at least one of a single use case complexity measure and a function of multiple use case complexity indicators;
computer useable program code for expressing the size of the software application as a function of one or more weighted complexities of the one or more use cases;
computer useable program code for collecting one or more use case measurements and one or more size measurements of the software application to create a size metric, wherein the one or more use case measurements and one or more size measurements are used to calibrate an estimation model; and
computer useable program code for correlating the size model with at least one of:
one or more other size metrics,
one or more analogous source lines of code, and
one or more function points.

19. The computer program product of claim 15, wherein in the computer useable code for inputting the MMV and the size into an effort model, development of the effort model comprises:
computer useable program code for measuring the software application in terms of at least one of one or more personnel characteristics, team distribution and amount of reuse to create one or more application metrics;
computer useable program code for developing the effort model as a function of the size model and one or more application metrics; and
computer useable program code for calibrating the effort model by collecting at least one of effort and one or more other metrics data.

20. A computer program product comprising a computer useable medium having computer useable program code for representing a detailed use case model (DUCM) of a software application, said computer program product including:
computer useable program code for obtaining a context model, wherein the context model describes one or more classes and one or more properties defining a domain of the software application;
computer useable program code for obtaining a behavior model, wherein the behavior model comprises one or more actors and a set of one or more use cases that the one or more actors can perform; and
computer useable program code for using the context model and the behavior model to represent a DUCM of the software application.

21. An apparatus for calculating effort of a software application, comprising:
a memory; and
at least one processor coupled to said memory and operative to:
obtain a detailed use case model (DUCM) of the software application;
compute a multi-dimensional metrics vector (MMV) based on the DUCM;
use a size model for the MMV to estimate a size of the software application; and
input the MMV and the size into an effort model, wherein the effort model is used to calculate the effort required to build the software application.

22. The apparatus of claim 21, wherein the DUCM comprises:
a behavioral model, wherein the behavioral model comprises a set of use cases and one or more use case descriptions; and
a data model, wherein the data model models one or more concepts used in the one or more use case descriptions.

23. The apparatus of claim 22, wherein each use case description comprises:
one or more input interactions between an actor and a system;
one or more output interactions between an actor and a system; and
one or more updates in system state.

24. The apparatus of claim 21, wherein in using a size model for the MMV to estimate a size of the software application, the at least one processor coupled to said memory is further operative to develop the size model, and wherein in developing the size model, the at least one processor coupled to said memory is further operative to:
determine complexity of one or more use cases based on the MMV of the DUCM, wherein complexity is indicated by at least one of a single use case complexity measure and a function of multiple use case complexity indicators;
express the size of the software application as a function of one or more weighted complexities of the one or more use cases;
collect one or more use case measurements and one or more size measurements of the software application to create a size metric, wherein the one or more use case measurements and one or more size measurements are used to calibrate an estimation model; and
correlate the size model with at least one of:
one or more other size metrics,
one or more analogous source lines of code, and
one or more function points.

25. The apparatus of claim 21, wherein in inputting the MMV and the size into an effort model, the at least one processor coupled to said memory is further operative to develop the effort model, and wherein in developing the effort model, the at least one processor coupled to said memory is further operative to:
measure the software application in terms of at least one of one or more personnel characteristics, team distribution and amount of reuse to create one or more application metrics;
develop the effort model as a function of the size model and one or more application metrics; and
calibrate the effort model by collecting at least one of effort and one or more other metrics data.
